(19) United States
(12) Patent Application Publication
(10) Pub. No.: US 2026/0298470 A1
(43) Pub. Date: Oct. 1, 2026

(54) GAS TURBINE COMBUSTOR AND GAS TURBINE

(71) Applicant: MITSUBISHI HEAVY INDUSTRIES, LTD., Tokyo (JP)

(72) Inventor: Satoshi TAKIGUCHI, Tokyo (JP)

(73) Assignee: MITSUBISHI HEAVY INDUSTRIES, LTD., Tokyo (JP)

(21) Appl. No.: 18/996,587

(22) PCT Filed: Feb. 24, 2023
(86) PCT No.: PCT/JP2023/006780

§ 371 Date: Jan. 17, 2025

(30) Foreign Application Priority Data
Jul. 21, 2022 (JP) 2022-116495

(51) Int. Cl. F23R 3/28; F02C 7/22

(52) U.S. Cl. CPC F23R 3/286; F02C 7/22

(57) ABSTRACT

According to the present invention, a gas turbine combustor and a gas turbine comprise: a combustion barrel having a cylindrical shape; a fuel supply unit for supplying a fuel gas into the combustion barrel; a premixed gas supply unit which supplies, into the combustion barrel, a premixed gas in which a fuel and air are mixed on a further downstream side from the fuel supply unit in the combustion gas flow direction; and a deflecting member which protrudes toward the center side of the combustion barrel from the inner wall surface of the combustion barrel between the fuel supply unit and the premixed gas supply unit, and deflects the combustion gas flow.

### TECHNICAL FIELD

The present disclosure relates to a gas turbine combustor and a gas turbine.

### BACKGROUND ART

The gas turbine includes a compressor, a combustor, and a turbine. The compressor compresses the taken-in air to generate high-temperature and high-pressure compressed air. The combustor obtains high-temperature and high-pressure combustion gas by supplying fuel to the compressed air and performing combustion. The turbine is driven by the combustion gas and drives a coaxially connected generator.

In order to improve efficiency and output of the gas turbine, it is considered to increase a combustion temperature. Meanwhile, it is necessary to reduce NOx generated during combustion, and a pre-mixed combustion method is adopted in order to decrease a maximum value of a flame temperature. However, in the pre-mixed combustion method, combustion vibration, which is an unstable event, is likely to occur, and an acoustic device is required. However, since the acoustic device needs to suppress backfire, purge air is required, and there is a problem that air for combustion is decreased and NOx increases.

As a technique for solving such a problem, a two-stage combustion method is available. In the two-stage combustion method, in a state where the flame temperature at a low load is low, by supplying air from a second-stage nozzle, the flame temperature on an upstream side can be increased, and generation of CO can be suppressed. In addition, in the two-stage combustion method, at a high load, a temperature of a first-stage flame region with a long retention time is suppressed to a low level by increasing a ratio of fuel to air in the second-stage nozzle as compared the ratio in a first-stage nozzle, and low NOx formation can be achieved as a whole.

### CITATION LIST

### Patent Literature

[PTL 1] Japanese Unexamined Patent Application Publication No. 2007-113888

### SUMMARY OF INVENTION

### Technical Problem

However, in the two-stage combustion method, at a low load, low-temperature air is supplied from the second-stage nozzle to be mixed with first-stage combustion gas. Therefore, the temperature of the main gas is rapidly decreased, the combustion of the fuel supplied from the first-stage nozzle is insufficient, and the generation of CO is caused. In addition, in the two-stage combustion method, at a high load, in a case where penetration power of the pre-mixed gas supplied from the second-stage nozzle with respect to the first-stage combustion gas is insufficient, mixing of the first-stage combustion gas and second-stage pre-mixed gas is insufficient. As a result, there is a problem in that a high-temperature region of the pre-mixed gas supplied from the second-stage nozzle remains, and NOx is generated.

The present disclosure is to solve the above-described problems, and an object of the present disclosure is to provide a gas turbine combustor and a gas turbine that suppress generation of CO by improving combustibility of the first-stage combustion gas and suppress generation of NOx by improving mixability between first-stage combustion gas and second-stage pre-mixed gas.

### Solution to Problem

In order to achieve the above-described object, a gas turbine combustor of the present disclosure includes: a combustion cylinder having a tubular shape; a fuel supply unit that supplies fuel gas to an inside of the combustion cylinder; a pre-mixed gas supply unit that supplies pre-mixed gas in which fuel and air are mixed inside of the combustion cylinder on a downstream side of the fuel supply unit in a flow direction of combustion gas; and a deflection member that deflects a flow of the combustion gas by protruding from an inner wall surface of the combustion cylinder toward a center side of the combustion cylinder between the fuel supply unit and the pre-mixed gas supply unit.

In addition, a gas turbine of the present disclosure includes: a compressor that compresses air to generate high-temperature and high-pressure compressed air; the gas turbine combustor that generates high-temperature and high-pressure combustion gas by supplying the fuel gas to the compressed air and combusting a mixture of the compressed air and the fuel gas; and a turbine that is driven by the combustion gas.

### Advantageous Effects of Invention

According to a gas turbine combustor and a gas turbine of the present disclosure, the generation of CO can be suppressed by improving the combustibility of the first-stage combustion gas, and the generation of NOx can be suppressed by improving the mixability between the first-stage combustion gas and the second-stage pre-mixed gas.

### BRIEF DESCRIPTION OF DRAWINGS

FIG. 1 is a schematic view showing an overall configuration of a gas turbine.

FIG. 2 is a cross-sectional view showing a gas turbine combustor according to a first embodiment.

FIG. 3 is a cross-sectional view showing a pre-mixed gas supply unit.

FIG. 4 is a cross-sectional view taken along line IV-IV of FIG. 2 showing a disposition relationship between a pre-mixed gas supply unit and a deflection member.

FIG. 5 is a cross-sectional view showing a modification example of a disposition relationship between a pre-mixed gas supply unit and a deflection member.

FIG. 6 is a cross-sectional view showing a pre-mixed gas supply unit in a gas turbine combustor according to a second embodiment.

FIG. 7 is a cross-sectional view showing a gas turbine combustor according to a third embodiment.

### DESCRIPTION OF EMBODIMENTS

Hereinafter, a preferred embodiment of the present disclosure will be described in detail with reference to the drawings. The present disclosure is not limited by the embodiment, and in a case where there are a plurality of embodiments, the present disclosure also includes a configuration in which the respective embodiments are combined with each other. In addition, components in the embodiments include those which can be easily assumed by those skilled in the art, those which are substantially the same, and those which have a so-called equivalent scope.

### First Embodiment

### Gas Turbine

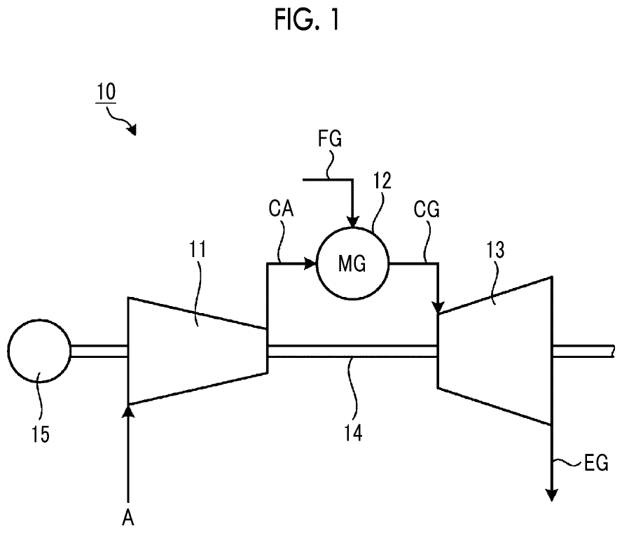

FIG. 1 is a schematic view showing an overall configuration of a gas turbine.

As shown in FIG. 1, a gas turbine 10 includes a compressor 11, a combustor (gas turbine combustor) 12, and a turbine 13. The compressor 11 and the turbine 13 can be integrally rotated by a rotary shaft 14. The generator 15 is connected to one end portion of the rotary shaft 14 in an axial direction. A plurality of combustors 12 are disposed at intervals in a circumferential direction between the compressor 11 and the turbine 13.

The compressor 11 compresses air A taken in from an air inlet through a plurality of stator vanes and rotor vanes to generate a high-temperature and high-pressure compressed air CA. The combustor 12 generates mixed gas MG by supplying fuel gas FG to the compressed air CA and generates a high-temperature and high-pressure combustion gas CG by combusting the mixed gas MG. The turbine 13 performs driving rotation of the rotary shaft 14 by allowing the combustion gas CG to pass through the stator vane and the rotor vane, and discharges exhaust gas EG. The generator 15 is driven by driving rotation of the rotary shaft 14 and generates electric power.

### Gas Turbine Combustor

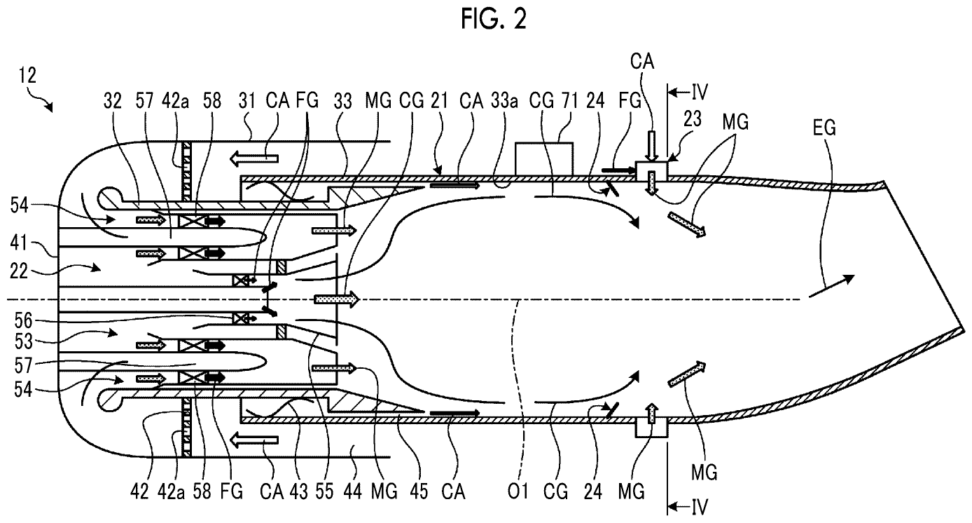

FIG. 2 is a cross-sectional view showing the gas turbine combustor according to a first embodiment.

As shown in FIG. 2, the combustor 12 includes a combustor body 21, a fuel supply unit 22, a pre-mixed gas supply unit 23, and a deflection member 24.

The combustor body 21 has a cylindrical shape with the axis Ol as a center. However, the combustor body 21 is not limited to the cylindrical shape, but may have an elliptical shape, or may have a tubular shape in which the area is changed along the axial direction. The combustor body 21 includes an outer cylinder 31, an inner cylinder 32, and a transition piece (combustion cylinder) 33. The combustor body 21 is configured by connecting the outer cylinder 31, the inner cylinder 32, and the transition piece 33 in series.

The fuel supply unit 22 supplies the fuel gas FG to an inside of the combustor body 21. Specifically, the fuel supply unit 22 supplies the mixed gas MG of the fuel gas FG and the compressed air CA to an inside of the inner cylinder 32. The pre-mixed gas supply unit 23 is disposed on a downstream side of the fuel supply unit 22 in a flow direction of the combustion gas CG. The pre-mixed gas supply unit 23 supplies the fuel gas FG inside of the combustor body 21. Specifically, the pre-mixed gas supply unit 23 supplies the compressed air CA or the mixed gas MG of the compressed air CA and the fuel gas FG into the transition piece 33.

The deflection member 24 is disposed between the fuel supply unit 22 and the pre-mixed gas supply unit 23 in an axis O1 direction. In this case, the deflection member 24 is disposed closer to the pre-mixed gas supply unit 23 than to the fuel supply unit 22. The deflection member 24 protrudes from an inner wall surface of the combustor body 21 toward a center (axis O1) side of the combustor body 21. Specifically, the deflection member 24 is fixed to an inner wall surface 33a of the transition piece 33, and deflects the flow of the combustion gas CG flowing along the inner wall surface 33a of the transition piece 33 to a center (axis O1) side of the transition piece 33.

Hereinafter, the combustor 12 will be described in detail.

A top hat portion 41 is connected to one end portion of the outer cylinder 31 in the axis O1 direction, an outer peripheral portion side of the other end portion is open, and the high-temperature and high-pressure compressed air CA generated by the compressor 11 (see FIG. 1) flows into the outer cylinder 31. One end portion of the inner cylinder 32 in the axis O1 direction is disposed inside the outer cylinder 31, and is connected to the outer cylinder 31 via the connecting member 42. The connecting member 42 has a ring shape, and a large number of through-holes 42a are formed in the connecting member 42. The connecting member 42 having a large number of through-holes 42a functions as a throttling member for the compressed air CA.

One end portion of the transition piece 33 in the axis O1 direction is disposed inside the other end portion of the outer cylinder 31 and outside the other end portion of the inner cylinder 32, and is supported by the inner cylinder 32 via the support member 43. An air passage 44 having a ring shape is formed between the other end portion of the outer cylinder 31 and one end portion of the transition piece 33. The compressed air CA flows to the connecting member 42 side through the air passage 44. In addition, an air passage 45 having a ring shape is formed between the other end portion of the inner cylinder 32 and one end portion of the transition piece 33. Some of the compressed air CA flows to the transition piece 33 through the air passage 45 and functions as film air flowing along the inner wall surface 33a.

In the inner cylinder 32, a pilot combustion burner 53 and a main combustion burner 54 are disposed. The pilot combustion burner 53 is disposed at the center (axis O1) of the inner cylinder 32. A plurality of main combustion burners 54 are disposed around the pilot combustion burner 53 at intervals in the circumferential direction.

The pilot combustion burner 53 includes a pilot cone 55 and a pilot nozzle 56. An end portion of the pilot cone 55 is supported in the inner cylinder 32. The pilot nozzle 56 is supported by the top hat portion 41 and is disposed inside the pilot cone 55. Although not shown, a revolving vane (swirler vane) is provided on an outer peripheral portion of the pilot nozzle 56. A pilot fuel line (not shown) is connected to the pilot nozzle 56.

The main combustion burner 54 includes a column 57 and a main nozzle 58. An end portion of the column 57 is supported by the top hat portion 41. The main nozzle 58 is disposed inside the column 57. The main nozzle 58 has a revolving vane (swirler vane). A main fuel line (not shown) is connected to the main nozzle 58.

In the first embodiment, the fuel supply unit 22 includes at least the pilot combustion burner 53 and a plurality of main combustion burners 54.

Therefore, the compressed air CA flows into the inner cylinder 32. The plurality of main combustion burners 54 jet and mix the fuel gas FG with respect to the compressed air CA to generate the mixed gas (pre-mixed gas) MG, and the mixed gas MG flows into the transition piece 33 as a swirling flow. Meanwhile, the pilot combustion burner 53 jets and mixes the fuel gas FG with respect to the compressed air CA to generate the mixed gas MG, and the mixed gas MG is ignited and combusted by the primary flame (not shown) to be jetted into the transition piece 33 as the combustion gas CG. In this case, some of the combustion gas CG is jetted into the transition piece 33 such that the combustion gas CG diffuses around the periphery with flame, whereby the mixed gas MG that has flowed into the transition piece 33 from each of the main combustion burners 54 is ignited and combusted. That is, with the flame of the fuel gas FG for the pilot jetted from the pilot combustion burner 53, it is possible to retain the flame for performing stable combustion of the fuel gas FG for the lean pre-mixing from the main combustion burner 54.

### Pre-Mixed Gas Supply Unit

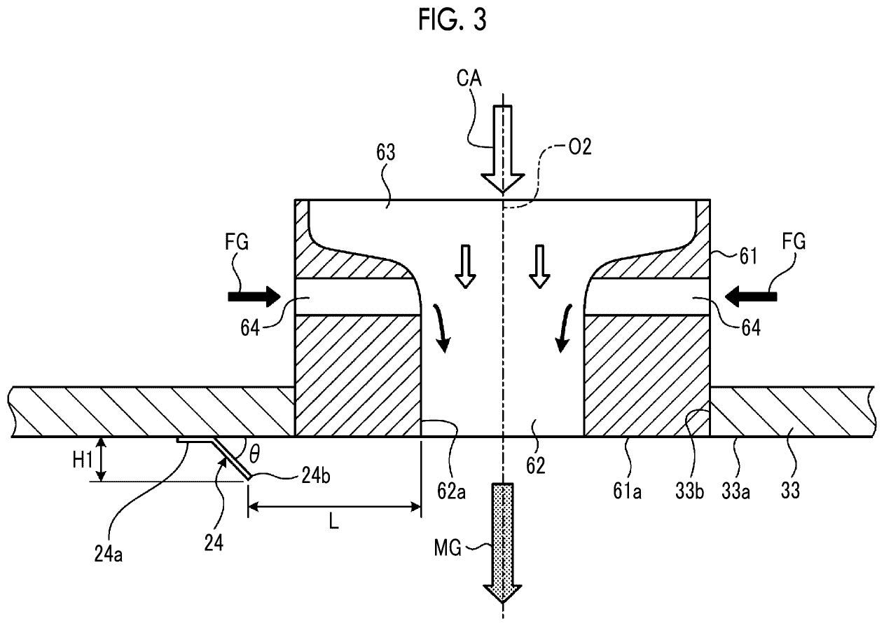

FIG. 3 is a cross-sectional view showing the pre-mixed gas supply unit.

As shown in FIGS. 2 and 3, the pre-mixed gas supply unit 23 is disposed on the downstream side of the fuel supply unit 22, and is capable of jetting only the compressed air CA inside the transition piece 33 and jetting the mixed gas (pre-mixed gas) MG of the compressed air CA and the fuel. A plurality of pre-mixed gas supply units 23 are disposed at intervals in the circumferential direction of the transition piece 33. In the pre-mixed gas supply unit 23, a jetting portion for jetting the mixed gas MG into the transition piece 33 is disposed along the inner wall surface 33a one the transition piece 33.

The pre-mixed gas supply unit 23 includes a housing 61, a jetting hole (jetting portion) 62, an air nozzle 63, and fuel nozzles 64.

The housing 61 is fitted to and fixed to a mounting hole 33b formed in the transition piece 33 from the outside. A front surface 61a of the housing 61 is continuous with the inner wall surface 33a of the transition piece 33 without a step. The jetting hole 62 has a circular shape and is provided along an axis O2 direction which is a radial direction of the transition piece 33 orthogonal to the axis O1 direction in the housing 61. The shape of the jetting hole 62 is not limited to the shape along the axis 02 direction orthogonal to the axis O1 direction, and the jetting hole 62 may be inclined to one side or the other side in the axis Ol direction or may be inclined in the circumferential direction of the transition piece 33. In addition, the jetting hole 62 is not limited to a circular shape and may have an elliptical shape, a polygonal shape (rectangular shape), or the like.

The jetting hole 62 is provided with an opening 62a that communicates with the inside of the transition piece 33 at one end portion in the axial direction, and the opening 62a is open to the inner wall surface 33a of the transition piece 33. The air nozzle 63 has a bell mouth shape. The air nozzle 63 has a concentric shape with the jetting hole 62, and a tip portion of the air nozzle 63 communicates with the jetting hole 62. An air line (not shown) is connected to the air nozzle 63. The compressed air CA from the compressor 11 (see FIG. 1) is supplied to the air line.

A plurality of fuel nozzles 64 are provided in the housing 61 in a direction orthogonal to the axis 02 direction around the jetting hole 62. The fuel nozzles 64 communicate with the jetting hole 62. The fuel nozzles 64 are connected to a fuel line (not shown), and an opening/closing valve (flow regulation valve) is provided in the fuel line.

Therefore, the compressed air CA is supplied from the air line to the air nozzle 63. Then, the air nozzle 63 jets the compressed air CA to the jetting hole 62. Meanwhile, the fuel gas FG is supplied from the fuel line to the fuel nozzles 64. Then, the fuel nozzles 64 jet the fuel gas FG to the jetting hole 62. As a result, the pre-mixed gas supply unit 23 jets the mixed gas MG of the compressed air CA and the fuel gas FG from the jetting hole 62 toward the inside of the transition piece 33.

### Deflection Member 24

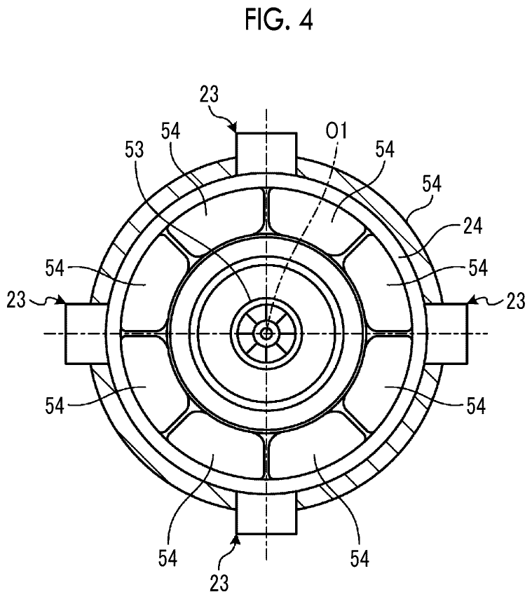

FIG. 4 is a cross-sectional view taken along line IV-IV of FIG. 2 showing a disposition relationship between the pre-mixed gas supply unit and the deflection member.

As shown in FIGS. 2 and 3, the deflection member 24 is provided on the upstream side of the pre-mixed gas supply unit 23 in the flow direction of the combustion gas CG in the inner wall surface 33a of the transition piece 33. The deflection member 24 protrudes from the inner wall surface 33a of the transition piece 33 toward the center (axis O1) side of the combustor body 21 and toward the downstream side in the flow direction of the combustion gas CG. The deflection member 24 includes a mounting portion 24a and a deflection portion 24b. The mounting portion 24a is fixed to the inner wall surface 33a of the transition piece 33, for example, by welding. The deflection portion 24b is integrally provided at an end portion of the mounting portion 24a at a predetermined angle. That is, the deflection member 24 is disposed as a member different from the transition piece 33.

In the deflection member 24, the deflection portion 24b is fixed to the inner wall surface 33 a of the transition piece 33 at a predetermined deflection angle θ. The deflection angle θ is preferably, for example, in a range of 30 degrees or more and less than 90 degrees. In this case, an inner diameter of the transition piece 33 is the same on the upstream side and the downstream side of the deflection member 24.

In addition, the pre-mixed gas supply unit 23 and the deflection member 24 have a predetermined positional relationship. That is, it is preferable that a distance L between the deflection member 24 and the pre-mixed gas supply unit 23 in the axis O1 direction is shorter than 10 times a radial length H1 of the transition piece 33 in the deflection member 24 that protrudes from the inner wall surface 33a of the transition piece 33. That is, it is preferable that the relationship between the distance L and the radial length H1 is L<10H1. Further, it is preferable that the relationship between the distance L and the radial length H1 is L<7H1.

Here, the distance L is a distance in the axis O1 direction from a downstream end of the deflection member 24 in the axis O1 direction to the jetting hole 62 of the pre-mixed gas supply unit 23. In addition, the radial length H1 is a radial length (axis O2 direction) of the transition piece 33 from the inner wall surface 33a of the transition piece 33 to a tip of the deflection member 24 in the deflection member 24.

Since the deflection member 24 deflects the flow of the combustion gas CG, a low-speed region of the combustion gas CG is formed on the downstream side. The relationship (L<7H) between the distance L and the radial length H1 in the pre-mixed gas supply unit 23 and the deflection member 24 is set in consideration of a back step flow in this case. That is, by applying the relationship (L<7H) between the distance L and the radial length H1, the combustion gas CG deflected by the deflection member 24 is less likely to flow toward the jetting hole 62 of the pre-mixed gas supply unit 23, and the flow of the combustion gas CG is less likely to affect the penetration power of the mixed gas MG jetted from the jetting hole 62 of the pre-mixed gas supply unit 23.

In addition, as shown in FIGS. 3 and 4, a plurality of pre-mixed gas supply units 23 are disposed at intervals (preferably, equal intervals) in the circumferential direction of the transition piece 33 (in the present embodiment, four pre-mixed gas supply units 23 are disposed, but the number thereof is not limited). The deflection member 24 is disposed at a position facing the plurality of pre-mixed gas supply units 23 in the axial direction (axis O1 direction) of the transition piece 33. That is, the deflection member 24 and the pre-mixed gas supply unit 23 are disposed at substantially the same position in the circumferential direction.

That is, the deflection member 24 has a ring shape. The deflection member 24 is disposed over the entire periphery of the inner wall surface 33a of the transition piece 33. Therefore, the deflection member 24 deflects the combustion gas CG over the entire periphery of the inner wall surface 33a flowing along the inner wall surface 33a of the transition piece 33 toward the pre-mixed gas supply unit 23 side to flow toward the center (axis O1) side of the combustor body 21.

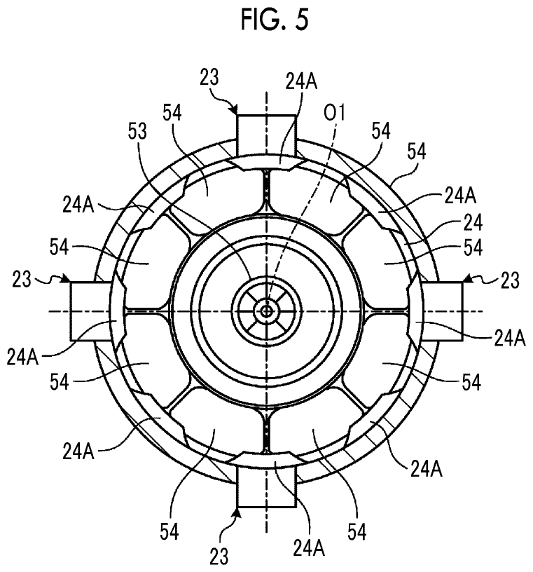

However, the deflection member 24 is not limited to the above-described shape. FIG. 5 is a cross-sectional view showing a modification example of a disposition relationship between the pre-mixed gas supply unit and the deflection member.

As shown in FIGS. 3 and 5, a plurality of pre-mixed gas supply units 23 are disposed at intervals in the circumferential direction of the transition piece 33. A plurality of deflection members 24A are disposed at positions facing the plurality of pre-mixed gas supply units 23 in the axial direction (axis O1 direction) of the transition piece 33.

That is, the plurality of (in the present embodiment, eight) deflection members 24A are disposed. Some (in the present embodiment, four) of the plurality of deflection members 24A are disposed at a position facing the four pre-mixed gas supply units 23 in the axis O1 direction. The remaining four deflection members 24A are disposed at positions facing intermediate positions of the four pre-mixed gas supply units 23 in the axis O1 direction. Therefore, the plurality of deflection members 24A deflect at least the combustion gas CG flowing toward the jetting hole 62 of each of the pre-mixed gas supply units 23 among from the combustion gas CG flowing along the inner wall surface 33a of the transition piece 33 to flow toward the center (axis O1) side of the combustor body 21.

In the combustor 12, vibration (combustion vibration) occurs in a case where the fuel is combusted. The combustion vibration causes noise or vibration during operation of the gas turbine 10. Therefore, an acoustic damper 71 is provided for the combustor 12 as a vibration source through which the combustion gas CG flows. The acoustic damper 71 is provided at the transition piece 33 in the combustor 12. The acoustic damper 71 attenuates the pressure fluctuation by taking in the air vibration (pressure wave) caused by the combustion vibration of the combustion gas CG through the through-hole of the transition piece 33 in a case where the combustion gas CG flows in the transition piece 33. The deflection member 24 (24A) is disposed on the downstream side of the acoustic damper 71 in the flow direction of the combustion gas CG.

### Function of Combustor

As shown in FIG. 2, in the fuel supply unit 22, the plurality of main combustion burners 54 jet the fuel gas FG into the compressed air CA to generate the mixed gas (pre-mixed gas) MG, and the mixed gas MG flows into the transition piece 33. The pilot combustion burner 53 jets the fuel gas FG into the compressed air CA to generate the mixed gas MG, ignites and combusts the mixed gas MG, and jets the combustion gas CG into the transition piece 33. Then, the fuel gas FG jetted from the main combustion burner 54 is ignited and lean combusted by the diffusion flame (or the pre-mixed flame) jetted from the pilot combustion burner 53.

The combustion gas CG generated by the combustion of the fuel gas FG supplied from the fuel supply unit 22 flows to the pre-mixed gas supply unit 23 side of the transition piece 33. In this case, the deflection member 24 (24A) deflects the direction of the combustion gas CG flowing along the inner wall surface 33a of the transition piece 33 to flow toward the center (the axis O1) side of the combustor body 21. In this state, the pre-mixed gas supply unit 23 jets the compressed air CA or the mixed gas MG from the jetting hole 62 toward the inside of the transition piece 33.

In low-load operation of the gas turbine 10 (see FIG. 1), the pre-mixed gas supply unit 23 jets the compressed air CA to the transition piece 33 with respect to the combustion gas CG generated by the combustion of the fuel gas FG supplied from the fuel supply unit 22. In this case, in the transition piece 33, in a region where the deflection member 24 (24A) is disposed, the deflection member 24 (24A) deflects the flow direction of the combustion gas CG toward the center side of the transition piece 33, and the flow is disturbed. In addition, some of the combustion gas CG swirls from the tip portion of the deflection member 24 (24A) to the inner wall surface 33a side of the transition piece 33 and generates a vortex, thereby performing flame retention. Therefore, the compressed air CA is jetted from the pre-mixed gas supply unit 23 with respect to the combustion gas CG having a disturbed flow, so that the combustion reaction is promoted by appropriately mixing the combustion gas CG and the compressed air CA, whereby the appropriate combustion of the combustion gas CG is ensured and the generation of CO is suppressed.

Meanwhile, in high-load operation of the gas turbine 10 (see FIG. 1), the pre-mixed gas supply unit 23 jets the mixed gas MG of the compressed air CA and the fuel gas FG to the transition piece 33 with respect to the combustion gas CG generated by the combustion of the fuel gas FG supplied from the fuel supply unit 22. In this case, in the transition piece 33, in the region where the deflection member 24 (24A) is disposed, the deflection member 24 (24A) deflects the flow direction of the combustion gas CG toward the center side of the transition piece 33. Then, in a region in front of the jetting hole 62 in the pre-mixed gas supply unit 23, the combustion gas CG flows toward the center side of the transition piece 33. As a result, the pre-mixed gas supply unit 23 has sufficient penetration power to jet the mixed gas MG toward the combustion gas CG, so that the combustion reaction is promoted by appropriately mixing the combustion gas CG and the mixed gas MG. Therefore, the fuel gas FG supplied from the pre-mixed gas supply unit 23 can be appropriately combusted, and the generation of NOx is suppressed.

### Second Embodiment

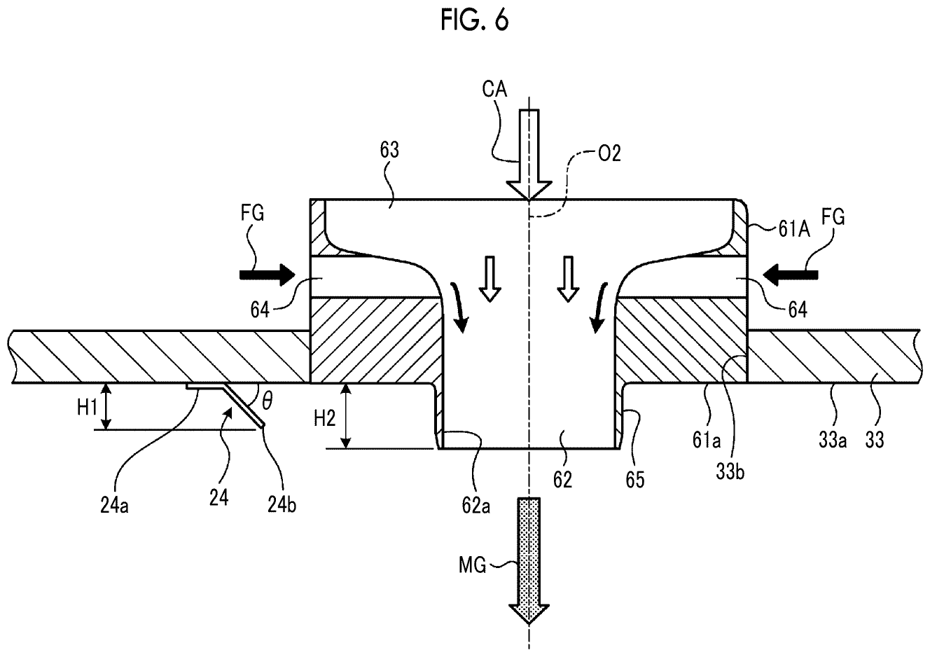

FIG. 6 is a cross-sectional view showing the pre-mixed gas supply unit in the gas turbine combustor according to a second embodiment. A basic configuration of the second embodiment is the same as that of the above-described first embodiment, and description will be made with reference to FIG. 2. The members having the same functions as in the above-described first embodiment will be denoted by the same reference numerals, and detailed description thereof will be omitted.

As shown in FIGS. 1 and 6, the pre-mixed gas supply unit 23A is disposed on the downstream side of the fuel supply unit 22, and is capable of jetting only the compressed air CA inside the transition piece 33 and jetting the mixed gas MG of the compressed air CA and the fuel. In the pre-mixed gas supply unit 23A, a jetting portion for jetting the fuel gas FG into transition piece 33 is disposed to protrude from the inner wall surface 33a of the transition piece 33 toward the transition piece 33.

The pre-mixed gas supply unit 23A includes the housing 61, the jetting hole (jetting portion) 62, the air nozzle 63, the fuel nozzles 64, and a guide portion 65.

The housing 61A is fitted to and fixed to the mounting hole 33b formed in the transition piece 33 from the outside. A front surface 61a of the housing 61 is continuous with the inner wall surface 33a of the transition piece 33 without a step. The jetting hole 62 is provided along the axis 02 direction which is a radial direction of the transition piece 33 orthogonal to the axis O1 direction in the housing 61. The tip portion of the air nozzle 63 communicates with the jetting hole 62.

A plurality of fuel nozzles 64 are provided around the jetting hole 62. The fuel nozzles 64 communicate with the jetting hole 62.

The guide portion 65 extends from the front surface 61a of the housing 61 toward the inside of the transition piece 33. The guide portion 65 has a cylindrical shape, is disposed concentrically with the jetting hole 62, and has an inner diameter equal to the inner diameter of the jetting hole 62. The guide portion 65 is not limited to a circular shape and may have an elliptical shape, a polygonal shape (rectangular shape), or the like. In addition, it is preferable that the guide portion 65 has a shape that matches the jetting hole 62, but may have a different shape. In addition, it is preferable that the guide portion 65 is provided over the entire periphery of the jetting hole 62, but, for example, a part of the guide portion 65 may be provided on the deflection member 24 side.

That is, the guide portion 65 protrudes from the inner wall surface 33a of the transition piece 33 to the transition piece 33 side, so that the jetting hole 62 extends to the inside of the transition piece 33. In this case, it is preferable that the radial length H2 of the transition piece 33 in the guide portion 65 protruding from the inner wall surface 33a of the transition piece 33 is equal to or longer than the radial length H1 of the transition piece 33 in the deflection member 24 protruding from the inner wall surface 33a of the transition piece 33.

The deflection member 24 is provided on the upstream side of the pre-mixed gas supply unit 23 in the flow direction of the combustion gas CG in the inner wall surface 33a of the transition piece 33. The deflection member 24 protrudes from the inner wall surface 33a of the transition piece 33 toward the center (axis O1) side of the combustor body 21 and toward the downstream side in the flow direction of the combustion gas CG.

Therefore, the pre-mixed gas supply unit 23A jets the compressed air CA or the mixed gas MG of the compressed air CA and the fuel gas FG to the transition piece 33 with respect to the combustion gas CG generated by the combustion of the fuel gas FG supplied from the fuel supply unit 22. In this case, since the jetting hole 62 is extended to the inside of the transition piece 33 by the guide portion 65, the penetration power of the mixed gas MG is improved in the pre-mixed gas supply unit 23A. In addition, since the deflection member 24 deflects the flow direction of the combustion gas CG toward the center side of the transition piece 33, the combustion reaction is promoted by appropriately mixing the combustion gas CG and the mixed gas MG. Therefore, the fuel gas FG supplied from the pre-mixed gas supply unit 23 can be appropriately combusted, and the generation of CO and NOx is suppressed.

### Third Embodiment

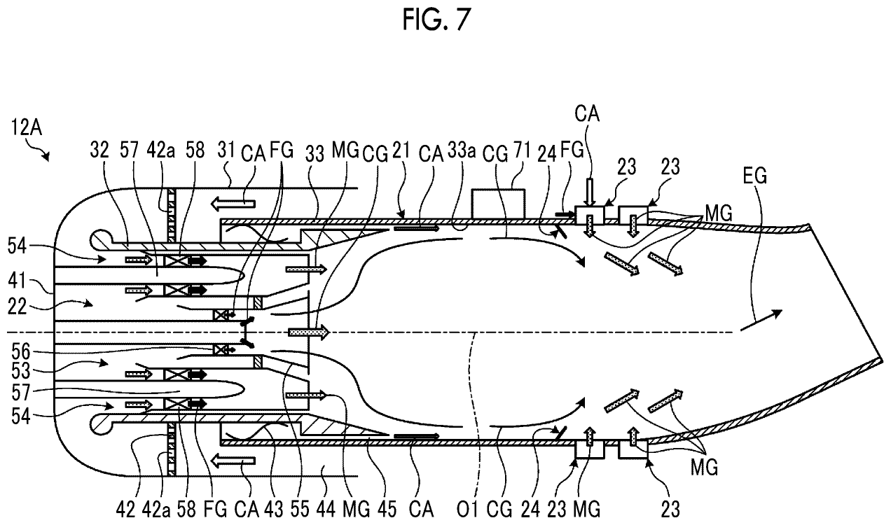

FIG. 7 is a cross-sectional view showing a gas turbine combustor according to a third embodiment. The members having the same functions as in the above-described first embodiment will be denoted by the same reference numerals, and detailed description thereof will be omitted.

As shown in FIG. 7, the combustor 12A includes the combustor body 21, the fuel supply unit 22, the pre-mixed gas supply unit 23, and the deflection member 24. The plurality of pre-mixed gas supply units 23 (two pre-mixed gas supply units 23 in the present embodiment, but the number is not limited) are disposed at intervals in the axial direction of the combustor body 21 (transition piece 33).

The plurality of pre-mixed gas supply units 23 are disposed on the downstream side of the fuel supply unit 22, and are capable of jetting only the compressed air CA inside the transition piece 33 and jetting the mixed gas MG of the compressed air CA and the fuel. The plurality of pre-mixed gas supply units 23 have the same configuration.

Therefore, each of the pre-mixed gas supply units 23 jets the compressed air CA or the mixed gas MG of the compressed air CA and the fuel gas FG to the transition piece 33 with respect to the combustion gas CG generated by the combustion of the fuel gas FG supplied from the fuel supply unit 22. In this case, since the deflection member 24 deflects the flow direction of the combustion gas CG toward the center side of the transition piece 33, the combustion reaction is promoted by appropriately mixing the combustion gas CG and the mixed gas MG. Therefore, the fuel gas FG supplied from the pre-mixed gas supply unit 23 can be appropriately combusted, and the generation of CO and NOx is suppressed.

### Operational Effects of Present Embodiment

A gas turbine combustor according to a first aspect includes the combustor body 21 having a tubular shape, the fuel supply unit 22 that supplies fuel gas FG to the inside of the combustor body 21, the pre-mixed gas supply units 23 and 23A that supply the mixed gas (pre-mixed gas) MG inside of the combustor body 21 on the downstream side of the fuel supply unit 22 in the flow direction of the combustion gas CG, and the deflection members 24 and 24A that deflect the flow of the combustion gas CG by protruding from the inner wall surface of the combustor body 21 toward the center side of the combustor body 21 between the fuel supply unit 22 and the pre-mixed gas supply units 23 and 23A.

In the gas turbine combustor according to the first aspect, the fuel supply unit 22 supplies the fuel gas FG to the combustor body 21, and the combustion gas CG generated by the combustion of the fuel gas FG flows to the pre-mixed gas supply unit 23 side. In this case, the deflection members 24 and 24A deflect the direction of the combustion gas CG to flow toward the center (axis O1) side of the combustor body 21. Then, the pre-mixed gas supply unit 23 supplies the mixed gas MG to the combustor body 21 in this state.

Therefore, for example, in the low-load operation of the gas turbine 10, the direction of the combustion gas CG is deflected by the deflection members 24 and 24A, and the flow is disturbed. As a result, the combustion reaction is promoted by appropriately mixing the combustion gas CG and the compressed air CA jetted from the pre-mixed gas supply unit 23, whereby the appropriate combustion of the combustion gas CG is ensured, and the generation of CO can be suppressed.

In addition, for example, in the high-load operation of the gas turbine 10, the direction of the combustion gas CG is deflected by the deflection members 24 and 24A. As a result, the penetration power of the mixed gas MG jetted from the pre-mixed gas supply unit 23 is increased, so that the combustion reaction is promoted by appropriately mixing the combustion gas CG and the mixed gas MG, whereby the appropriate combustion of the fuel gas FG is ensured and the generation of NOx can be suppressed.

A gas turbine combustor according to a second aspect is the gas turbine combustor according to the first aspect, in which, in the pre-mixed gas supply units 23 and 23A, the jetting hole (jetting portion) 62 for jetting the mixed gas MG into the combustor body 21 is disposed along the inner wall surface of the combustor body 21. Accordingly, the protrusion on the inner wall surface of the combustor body 21 can be eliminated, so that the fluidity of the combustion gas CG can be improved.

A gas turbine combustor according to a third aspect is the gas turbine combustor according to the first aspect, in which, in the pre-mixed gas supply units 23 and 23A, the jetting hole (jetting portion) 62 for jetting the mixed gas MG into the combustor body 21 is disposed to protrude from the inner wall surface of the combustor body 21 toward the inside of the combustor body 21. As a result, the penetration power of the mixed gas MG jetted from the jetting hole 62 of the pre-mixed gas supply units 23 and 23A with respect to the combustion gas CG can be improved.

The gas turbine combustor according to a fourth aspect is the gas turbine combustor according to the first aspect to the third aspect, in which, the distance L between the deflection members 24 and 24A and the pre-mixed gas supply units 23 and 23A in the axial direction of the combustor body 21 is shorter than 10 times the radial length H1 of the combustor body 21 in the deflection members 24 and 24A protruding from the inner wall surface of the combustor body 21. As a result, the combustion gas CG directed toward the jetting hole 62 side of the pre-mixed gas supply units 23 and 23A can be appropriately decreased by the deflection members 24 and 24A.

The gas turbine combustor according to a fifth aspect is the gas turbine combustor according to the first aspect to the fourth aspect, in which the plurality of pre-mixed gas supply units 23 and 23A are disposed at intervals in the circumferential direction of the combustor body 21, and the deflection members 24 and 24A are disposed at positions facing the plurality of pre-mixed gas supply units 23 and 23A in the axial direction of the combustor body 21. As a result, the deflection members 24 and 24A can appropriately reduce the influence of the combustion gas CG on the mixed gas MG jetted from the pre-mixed gas supply units 23 and 23A.

The gas turbine combustor according to a sixth aspect is the gas turbine combustor according to the first aspect to the fifth aspect, in which the plurality of pre-mixed gas supply units 23 and 23A are disposed at intervals in the axial direction of the combustor body 21. As a result, the generation of NOx can be suppressed by improving the mixability between the combustion gas CG generated by the combustion of the fuel gas FG supplied from the fuel supply unit 22 and the mixed gas MG supplied from the pre-mixed gas supply units 23 and 23A.

The gas turbine according to a seventh aspect includes a compressor 11 that compresses air A to generate the high-temperature and high-pressure compressed air CA, the combustor 12 according to the first aspect to the sixth aspect which generates the high-temperature and high-pressure combustion gas CG by supplying the fuel gas FG to the compressed air CA and combusting the mixture of the compressed air CA and the fuel gas FG, and a turbine 13 driven by the combustion gas CG. As a result, the combustibility of the first-stage combustion gas FG can be improved to suppress the generation of CO, and the mixability between the first-stage combustion gas CG and the second-stage mixed gas MG can be improved to suppress the generation of NOX.

In the above-described embodiment, the pilot combustion burner 53 and the plurality of main combustion burners 54 are provided as the fuel supply unit 22, but the present invention is not limited to this configuration.

### Reference Signs List

10: gas turbine
11: compressor
12, 12A: combustor (gas turbine combustor)
13: turbine
14: rotary shaft
21: combustor body
22: fuel supply unit
23, 23 A: pre-mixed gas supply unit
24, 24A: deflection member
31: outer cylinder
32: inner cylinder
33: transition piece (combustion cylinder)
33a: inner wall surface
41: top hat portion
42: connecting member
43: support member
44, 45: air passage
53: pilot combustion burner
54: main combustion burner
55: pilot cone
56: pilot nozzle
57: column
58: main nozzle
61, 61A: housing
62: jetting hole (jetting portion)
63: air nozzle
64: fuel nozzle
65: guide portion
71: acoustic damper
A: air
CA: compressed air
FG: fuel gas
MG: mixed gas
CG: combustion gas
EG: exhaust gas
O1, O2: axis

1. A gas turbine combustor comprising:
a combustion cylinder having a tubular shape;
a fuel supply unit that supplies fuel gas to an inside of the combustion cylinder;
a pre-mixed gas supply unit that supplies pre-mixed gas in which fuel and air are mixed inside of the combustion cylinder on a downstream side of the fuel supply unit in a flow direction of combustion gas; and
a deflection member that deflects a flow of the combustion gas by protruding from an inner wall surface of the combustion cylinder toward a center side of the combustion cylinder between the fuel supply unit and the pre-mixed gas supply unit,
wherein the deflection member is disposed at a predetermined angle with respect to the combustion cylinder as a member different from the combustion cylinder.

2. The gas turbine combustor according to claim 1, wherein
in the pre-mixed gas supply unit, a jetting portion for jetting the pre-mixed gas into the combustion cylinder is disposed along the inner wall surface of the combustion cylinder.

3. The gas turbine combustor according to claim 1, wherein
in the pre-mixed gas supply unit, a jetting portion for jetting the pre-mixed gas into the combustion cylinder is disposed to protrude from the inner wall surface of the combustion cylinder toward the inside of the combustion cylinder.

4. The gas turbine combustor according to claim 1, wherein
a distance L between the deflection member and the pre-mixed gas supply unit in an axial direction of the combustion cylinder is shorter than 10 times a radial length H1 of the combustion cylinder in the deflection member protruding from the inner wall surface of the combustion cylinder.

5. The gas turbine combustor according to claim 1, wherein
a plurality of the pre-mixed gas supply units are disposed at intervals in a circumferential direction of the combustion cylinder, and the deflection member is disposed at a position facing the plurality of pre-mixed gas supply units in an axial direction of the combustion cylinder.

6. The gas turbine combustor according to claim 1, wherein
a plurality of the pre-mixed gas supply units are disposed at intervals in an axial direction of the combustion cylinder.

7. A gas turbine comprising:
a compressor that compresses air to generate high-temperature and high-pressure compressed air;
the gas turbine combustor according to claim 1 which generates high-temperature and high-pressure combustion gas by supplying the fuel gas to the compressed air and combusting a mixture of the compressed air and the fuel gas; and
a turbine that is driven by the combustion gas.
